(19) United States
(12) Patent Application Publication
(10) Pub. No.: US 2026/0222060 A1
(43) Pub. Date: Jul. 30, 2026

(54) Methods and Apparatuses for Enhancing Availability via Multi-Satellite Diversity

(71) Applicant: ViaSat, Inc., Carlsbad, CA (US)

(72) Inventors: Kenneth V. Buer, Bluff City, TN (US); James E. Petranovich, La Jolla, CA (US)

(21) Appl. No.: 19/139,605

(22) PCT Filed: Dec. 19, 2023
(86) PCT No.: PCT/US2023/084909

§ 371 Date: Jun. 16, 2025

Related U.S. Application Data
(60) Provisional application No. 63/476,154, filed on Dec. 19, 2022.

(51) Int. Cl. H04B 7/185; H04B 7/06; H04B 7/195; H04L 41/16

(52) U.S. Cl. CPC H04B 7/1855; H04B 7/0626; H04B 7/195; H04L 41/16

(57) ABSTRACT

A satellite communications network (SCN) advantageously features selective use of diversity and non-diversity service modes, with respect to serving individual user terminals (UTs) using a constellation of non-geosynchronous satellites included in the SCN. For example, with respect to serving any given UT, the SCN may switch from a non-diversity service mode to a diversity service mode, responsive to determining that non-diversity service involves one or more restricted viewing angles. The restricted viewing angles may be learned for the UT location based on past monitoring by the SCN or may be estimated from viewing angle restrictions learned for one or more locations nearby the UT location.

### TECHNICAL FIELD

In the context of a satellite communications network that includes a constellation of non-geosynchronous satellites, disclosed methods and apparatuses relate to the selective use of non-diversity or diversity service modes, for serving respective user terminals supported by the network.

### BACKGROUND

Any given user terminal (UT) has a nominal “field of view,” referring to the nominal range of angles over which the terminal can see to communicate with a satellite. For example, as a matter of design, a UT has a nominal range of elevational angles over which the UT can establish and maintain communications with a satellite.

In a constellation of non-geosynchronous orbit (NGSO) satellites, each satellite moves relative to the surface of the Earth, meaning that each satellite provides a moving coverage area, with the ground footprint of that coverage area following a ground track corresponding to the orbital path of the satellite. A satellite in the constellation is a candidate for serving a given UT, to the extent that field of view of the UT overlaps with the coverage area of the satellite. Here, “serving” refers to providing communication services to the UT.

In a typical approach, SCNs based on constellations of NGSO satellites serve respective UTs without diversity, meaning that one satellite at a time in the constellation serves any given UT. The serving satellite changes as different satellites in the constellation move into and out of the field of view of the given UT. Serving satellite changes are referred to as “handovers” of the UT.

Serving UTs without diversity offers a number of advantages, such as simplifying scheduling and corresponding management of forward and/or return data flows within the ground and space segments of the SCN for individual terminals. However, degradation in availability or at least the heightened risk of degraded availability arises in the context of non-diversity service. “Availability” in this context refers to the degree to which a SCN is accessible and capable of providing a reliable connection to a user terminal. However, addressing the availability problem involves manifold considerations. Considerations include but are not limited to traffic scheduling complexities, network throughput, resource utilization efficiency, and how to make intelligent decisions about whether and when to use diversity techniques for serving given UTs.

### SUMMARY

A satellite communications network (SCN) advantageously features selective use of diversity and non-diversity service modes, with respect to serving individual user terminals (UTs) using a constellation of non-geosynchronous satellites included in the SCN. For example, with respect to serving any given UT, the SCN may switch from a non-diversity service mode to a diversity service mode, responsive to determining that non-diversity service involves one or more restricted viewing angles. The restricted viewing angles may be learned for the UT location based on past monitoring by the SCN or may be estimated from viewing angle restrictions learned for one or more locations nearby the UT location.

One embodiment comprises a method performed by a control apparatus operating in a SCN comprising a constellation of non-geosynchronous satellites following respective orbital paths. The method includes the SCN learning viewing angle restrictions for corresponding geographic locations, based on collecting connectivity metrics over time for given UTs operating in the corresponding locations, wherein the connectivity metrics collected for each such location indicate viewing angles characteristically associated with degraded connectivity. The method further includes the SCN serving a UT in a non-diversity service mode, in which there is a single serving satellite at a time in the constellation for the UT, and predicting that the UT will experience degraded connectivity, based on the learned viewing angle restrictions. The method further includes, in response to the prediction, the SCN deciding to change from serving the UT in the non-diversity service mode to serving the UT in a diversity service mode, in which there are two or more serving satellites at a time in the constellation for the UT and serving the UT in the diversity service mode.

A related embodiment comprises a control apparatus configured for operation in a SCN comprising a constellation of non-geosynchronous satellites following respective orbital paths, the control apparatus includes communication interface circuitry and processing circuitry. The processing circuitry is configured to learn viewing angle restrictions for corresponding geographic locations, based on collecting connectivity metrics over time for given user terminals (UTs) operating in the corresponding locations. The connectivity metrics collected for each such location indicate viewing angles characteristically associated with degraded connectivity.

The processing circuitry of the diversity control apparatus is further configured to serve a UT in a non-diversity service mode, in which there is a single serving satellite at a time in the constellation for the UT, and predict that the UT will experience degraded connectivity, based on the learned viewing angle restrictions. The processing circuitry is configured to, responsive to the prediction, decide to change from serving the UT in the non-diversity service mode to serving the UT in a diversity service mode, in which there are two or more serving satellites at a time in the constellation for the UT, and serve the UT in the diversity service mode.

Another embodiment comprises a method of operation by a UT configured to be served by a SCN comprising a constellation of non-geosynchronous satellites following respective orbital paths. The method includes the UT operating in a non-diversity service mode, wherein the SCN serves the UT via a single serving satellite at a time in the constellation, the UT receiving control signaling from the SCN, indicating a change from the non-diversity service mode to a diversity service mode, wherein the SCN serves the UT via two or more serving satellites at a time in the constellation, and the UT changing from operating in the non-diversity service mode to operating in the diversity service mode. The UT changes in response to one of: reception of the control signaling, or satisfaction of a diversity-mode trigger condition indicated by the control signaling.

A related embodiment comprises a UT configured to be served by a SCN comprising a constellation of non-geosynchronous satellites following respective orbital paths. The UT includes communication interface circuitry configured to communicate with the SCN, via exchanging wireless signaling with one or more satellites in the constellation. The UT further includes processing circuitry that is operatively associated with the communication interface circuitry and configured to: operate in a non-diversity service mode, wherein the SCN serves the UT via a single serving satellite at a time in the constellation; receive control signaling from the SCN, indicating a change from the non-diversity service mode to a diversity service mode, wherein the SCN serves the UT via two or more serving satellites at a time in the constellation; and change from operating in the non-diversity service mode to operating in the diversity service mode, in response to one of: reception of the control signaling, or satisfaction of a diversity-mode trigger condition indicated by the control signaling.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a satellite communications network (SCN), according to an example embodiment.

FIG. 2 is a logic flow diagram of a method of operation by a diversity control apparatus in a SCN, according to an example embodiment.

FIG. 3 is a logic flow diagram of another method of operation by a diversity control apparatus, according to an example embodiment.

FIG. 4 is a block diagram of a diversity control apparatus, according to an example embodiment.

FIG. 5 is a block diagram of a machine learning (ML) model instantiated in a run-time environment, for diversity control decision-making according to one embodiment.

FIG. 6 is a block diagram of circuitry configured to split data streams into two or more data sub-streams for diversity transmission, according to an example embodiment.

FIGS. 7 and 8 are diagrams illustrating example viewing angles for a UT at a given location, including restricted viewing angles.

FIG. 9 is a diagram of an example satellite service area containing a number of locations for which viewing angle restrictions have been characterized by a SCN.

FIG. 10 is a block diagram of an example database structure, as may be used for holding data indicating learned viewing angle restrictions for a potentially large number of locations.

FIG. 11 is a logic flow diagram of a method of operation by a UT, according to an example embodiment.

FIG. 12 is a block diagram of a UT, according to an example embodiment.

### DETAILED DESCRIPTION

One approach to enhancing the availability of a satellite communications network (SCN) relies on cooperative beamforming from multiple-two or more-satellites. Various techniques may be used to beamform by selecting a particular satellite for beamforming from among multiple satellites, and/or adaptively incorporating signals from two or more satellites for beamforming.

In some embodiments, one or more of the following may be done with respect to serving a user terminal (UT) with diversity: (a) polarization combining from a single satellite, which includes (i) selecting a best one of two polarizations in a faded environment or (ii) combining two polarizations in an adaptive optimal way; (b) diversity selection, which includes (i) picking a best satellite, such as based on signal strength, or (ii) adaptively monitoring and dynamically selecting a best one among multiple satellites; and (c) diversity combining, which includes (i) combining signals to/from multiple satellites in an adaptive optimal way, and may further include (ii) performing interference cancellation, based on the use of channel sounding.

Diversity combining also may include interleaving and applying forward error correction (FEC) coding to the data to be relayed via the multiple satellites. In a forward downlink example, the involved UT receives a respective signal from each of the multiple satellites, with the UT demodulating data from each such signal, and then combining and sequencing the data according to the FEC coding. The respective signals may use any one or more of different CDMA codes, different polarizations, different frequencies, or different timeslots.

One aspect of interest herein is the selective use of diversity from multiple non-geosynchronous orbit (NGSO) satellites, to enhance availability of a SCN to a handset operating in L-band. Of course, the disclosed methods and apparatus apply directly to other frequency bands and other types of satellite receivers. Although enhanced availability via diversity stands as a key benefit, use of diversity also may enhance link budget and/or throughput. Unless otherwise stipulated or evident from the context, the term “satellite” means a NGSO satellite, and any references to a “constellation” may be understood as referring to a constellation of NGSO satellites, unless otherwise stipulated or evident from the context.

One or more embodiments disclosed herein are based on the assumption that the location and velocity of each satellite in a constellation is known reasonably accurately to the ground stations that provide forward traffic for relaying via satellites in the constellation. In a particular example involving the selective use of diversity or non-diversity service, there are at least two satellites in a constellation of NGSO satellites that are candidates for serving a given UT, e.g., a handset. The involved SCN includes one or more ground stations—also referred to as base stations—that are communicatively coupled directly or indirectly with the two or more candidate satellites in the constellation, for relaying forward traffic—user data—to the given UT via a forward link and/or relaying return traffic from the UT via a return link. Unless otherwise noted or apparent from the context, “satellite” as used herein refers to a NGSO satellite.

With two or more candidate satellites, the SCN may choose to serve the UT in a non-diversity service mode, meaning that the UT is served by a single satellite at a time in the constellation, or in a diversity service mode, meaning that the UT is served by multiple—two or more—satellites at a time in the constellation.

Diversity service mode improves availability because the multiple serving satellites means that service may continue, albeit with reduced throughput or other degradations, even during instances for which the UT experiences fading with respect to one of its multiple serving satellites. Generally, availability will be degraded with respect to a given serving satellite due to problems near the UT, such as: (a) shadowing caused by large objects like hills or massive structures, where such shadowing may be persistent and affect all or most propagation paths between the UT and the serving satellite; (b) blockages caused by narrow objects like trees or leaves, where such blockages may be persistent but affect a limited number of propagation paths between the UT and the serving satellite; and (c) scattering, often resulting from the satellite signal bouncing off an object and causing multipath, with scattering being problematic only when the elevation angle the serving satellite is low and the ground near the UT is highly reflective.

All such problems may be understood as degrading connectivity between a given UT and its serving satellite. Most of the time, connectivity for the given UT will be quite good using a single serving satellite, as the signal(s) move through space with a clear line of sight and minimal scattering. However, some combinations of terminal location and satellite location may result in blockages, shadowing, or reflection. Put another way, it may be that a given UT is operating with a viewing angle safely within its nominal range of viewing angles and nonetheless experiences degraded connectivity because of the local environment. Degraded connectivity corresponds with degraded availability.

Availability enhancement in one or more embodiments is based on the following operational logic in a SCN: (a) if a UT operating in a non-diversity service mode experiences or is expected by the SCN to experience degraded availability, the SCN switches the UT to a new serving satellite, assuming that there is another satellite in the constellation that currently is a candidate for serving the UT; (b) if there is no other satellite that is a current candidate for serving the UT or if the UT experiences or is expected to experience degraded availability with respect to all candidate satellites, the SCN takes one of two actions: (i) it pauses traffic scheduling for the UT to avoid sending user traffic to (or receiving user traffic from) the UT at times corresponding to the degraded availability, or (ii) it selects a diversity service mode for serving the UT from multiple satellites in the constellation.

One approach involves the SCN developing and maintaining a short-term history—a database—for UTs, for use in predicting locations where there is or might be degraded availability. The database thus represents a type of short-term spatial database. When there is one problematic satellite with respect to serving a UT, a scheduling algorithm changes serving satellites. When all candidate satellites for the UT are problematic, there are two options: one is to delay the communications until one of the candidate satellites moves to a better location.

Delay works for certain types of communication services, such as low priority data transfers, e.g., software download or some text transfer. For other more latency sensitive types of communication services, the SCN activates a diversity technique. This decision making process can use machine learning to improve its understanding of when diversity is needed. One benefit of selective use of diversity service, among the several benefits, is that the SCN does not unnecessarily tie up two satellites when not needed for good availability.

Regarding diversity service in a return-link direction, where traffic goes from the UT to one or more satellites in the constellation and then down to a ground network of the SCN, the return link signals conveying such traffic may be received at multiple base stations, with the SCN then moving the physical (PHY) layer data—either sampled analog-to-digital-conversion (ADC) data or down-sampled, processed data at some level—through the ground network and/or through external network links, for aggregation in a common processing entity. Once the data is aggregated, the SCN can use a variety of techniques to recover data reliably. These techniques could include any one or combination of: (a) estimating the gain and phase of each channel, and then using that estimate to implement optimal combining techniques; (b) trying to receive the return data independently through any of the multiple serving satellites.

In a forward direction going from the ground network to the constellation and then to the UT, one diversity technique is optimal single channel Multiple-Input-Single-Output (MISO) or Multiple-Input-Multiple-Output (MIMO). Here, the “multiple input” refers to transmissions from two or more satellites in the constellation. Using MIMO or MISO transmission for diversity in the forward direction means transmitting from two or more satellites at precise times and with predetermined gain and phase adjustment such that the two or downlink signals combine optimally when received at the UT. Such operations can be understood as cooperative beamforming between or among the two or more satellites participating in the MIMO or MISO transmission.

Consider a forward MISO case where there are two satellite access nodes (SANs) in the ground network of the SCN, each SAN associated with a corresponding satellite in the constellation, and with each such satellite being a serving satellite with respect to a given UT. In one embodiment, both SANs send the same basic signal, but with different frequency, gain, phase, and delay such that the resulting downlink signals from the two satellites add together constructively at the given UT. While MISO in some respects is a known technique, employment of MISO for diversity service in the satellite environment requires innovative use of ephemeris and corresponding dynamic adjustment of the involved channel estimates as a function of relative movement between the multiple serving satellites and the given UT. The channel estimates may be obtained via channel sounding, in which sounding signals are transmitted and received via the two or more satellites, for estimation of the physical channels between the UT and the SCN from or through each of the serving satellites. For example, the SCN sends different orthogonal signals from each ground station to allow a UT to estimate the channel and send the estimates back, with the SCN performing dynamic adjustment of the channel estimates to account for the motion of the satellites.

Regarding the dynamic adjustment of the channel estimates, in one or more embodiments, the SCN performs dynamic adjustment of past channel estimates to predict new estimates. The SCN uses a linear or a maximum-likelihood channel estimator, for example, for prediction of the future channels. Further, at the future time, the SCN may use the current/most-recent sounding information to estimate the error in the corresponding predicted estimate. By repeating this process, the SCN can correct not just the past estimates but the future ones. This might take the form of estimating rate of channel phase and gain change or rate of channel delay change. Once the estimator circuit used in the SCN is trained, it enables the SCN to send diversity signals to the given UT that combine optimally or nearly optimally.

Another technique is MISO with time offset. This technique involves transmitting the same signal for the UT from each of the multiple serving satellites, but with a defined inter-signal delay. If the delay is large enough, then the UT can use a rake-receiver type structure to combine the two signals. Such a receiver adjusts the frequency, gain, and phase of the two or more received signals so that they add constructively. One challenge with this structure is to avoid increasing self-interference caused by the delay. One way to mitigate this problem is to make the delay(s) long enough so that only one of the two or more serving satellites is transmitting at a time in the precise location of the UT. Of course, the serving satellites could transmit to other locations. Another way to mitigate the problem is to make the delay long compared with a symbol rate use a maximum-likelihood decoder algorithm that will in effect ignore the effect of the delayed signal(s). A third way to mitigate the problem is to use direct sequence spread spectrum techniques to make the delayed signal nearly orthogonal to the non-delayed signal.

Frequency diversity is another example of a forward diversity technique. With frequency diversity, each serving satellite transmits to the UT using a different frequency. The multiple downlink signals may be duplicates, e.g., each diversity downlink signal conveys the same content—same traffic. The UT can use any one of various techniques for recovering the content—including best-signal selection and/or multi-signal combining. As an advantage, this approach is simple, but it uses more signal bandwidth.

Another forward diversity technique is message diversity. With message diversity, the multiple serving satellites transmit the same message targeting the UT, but at different times and possibly using different frequencies. On the plus side, message diversity can be implemented at various levels in the communications protocol stack and offers relatively simple implementation, but it uses more capacity. Or, said differently, message diversity has lower efficiency because of the duplicate transmission of the same message.

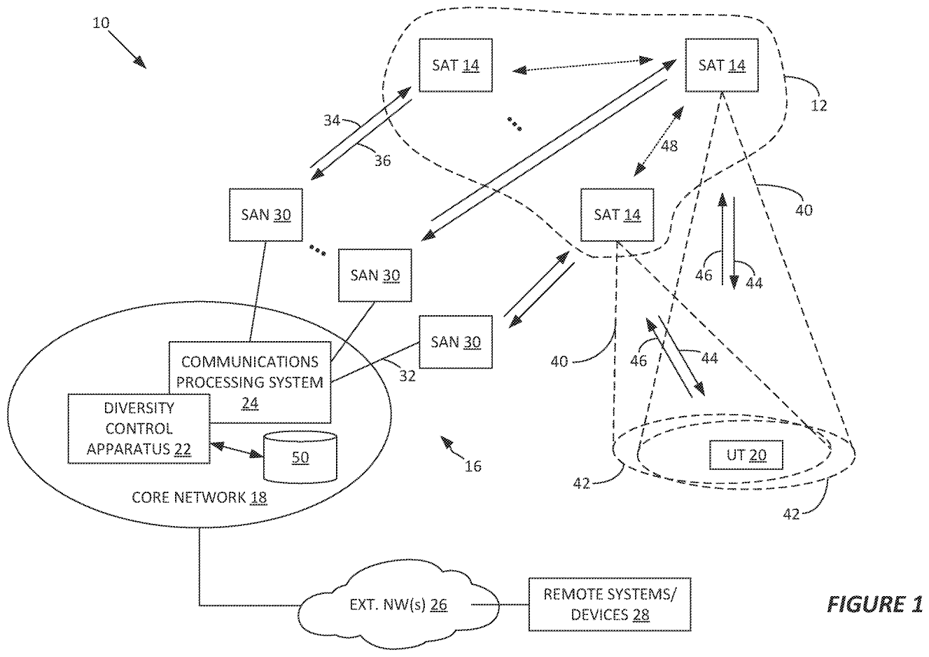

FIG. 1 illustrates a SCN 10 according to an example embodiment, where the SCN 10 comprises a constellation 12 of NGSO satellites 14. As an example, the satellites 14 are LEO satellites or medium Earth orbit (MEO) satellites. Further, the SCN 10 includes a ground network 16 that includes a core network (CN) 18. Of particular interest herein, the ground network 16 is configured to use diversity on a selective basis-dynamically decided basis-with respect to individual UTs 20 served by the SCN 10. FIG. 1 illustrates a single UT 20 for simplicity of illustration and discussion, and it shall be understood that the SCN 10 is operative to serve potentially many UTs 20, such as a population of UTs 20 spread over a large geographic region covered by the constellation 12.

With dynamic diversity, the SCN 10 decides whether and when to serve a given UT 20 using a non-diversity service mode or using a diversity service mode. The diversity service mode itself may use a particularly selected one among two or more diversity techniques. That is, there may be various techniques to select from for operation in the diversity service mode, e.g., in dependence on whether diversity is used in the forward direction or the return direction, or both. Other variables influencing the particular diversity techniques used include the configuration and capabilities of the SCN 10 and that of the involved UT(s) 20, and, possibly, the type of communication service involved.

In the illustrated example, the CN 18 includes a diversity control apparatus 22 that is configured to decide whether the SCN 10 serves a given UT 20 in a non-diversity service mode or in a diversity service mode. The diversity control apparatus 22 is communicatively coupled with or integrated within a communications processing system (CPS) 24 that performs user scheduling of forward and return user traffic for respective UTs 20 in the overall population of UTs 20 served by the SCN 10. In particular, the CPS 24 is configured to interface with one or more external networks 26, such as the Internet, and to supporting routing of user data streams going between one or more types of remote devices or systems 28 and respective ones of the UTs 20 supported by the SCN 10. In this regard, the SCN 10 shall be understood as providing one or more types of communication services to respective UTs 20, such as mobile broadband service or other types of data and/or voice connectivity.

The CPS 24 comprises fixed circuitry or programmatically configured circuitry, or a mix of both. In one or more embodiments, the CPS 24 comprises one or more computer servers, each such server comprising one or more microprocessors or other type of digital processor, a communications interface such as an Ethernet or other data network interface, and memory and/or storage containing computer program instructions that, when executed by the one or more microprocessors or other type of digital processor, configure such processor(s) to cause the CPS 24 to perform user scheduling and to interact with (or implement) the diversity control apparatus 22. User scheduling, as noted, involves scheduling forward and/or return traffic for individual ones among the population of UTs 20 served by the SCN 10.

Of course, because of the relative movement of the satellites 14 and the UTs 20, scheduling user traffic includes mapping the respective traffic flows to different satellites 14 at different times, in dependence on which satellite(s) 14 in the constellation 12 are candidates for serving a particular UT 20 at any given time. To that end, the ground network 16 includes a plurality of satellite access nodes 30 that are geographically distributed.

Forward traffic targeting individual UTs 20 flows from one or more of the SANs 30 to the constellation 12, and the satellites 14 in the constellation 12 may participate in mesh routing of that traffic, for downlink transmission by the particular satellite(s) 14 serving the targeted UTs 20. Broadly, the CPS 24 has network links 32 to each SAN 30, such that, at any given time, it can send or receive user traffic for any given UT 20 to or from one or more SAN(s) 30 for direct or meshed transmission to the satellite(s) 14 that are then serving the given UT 20.

Correspondingly, each SAN 30 includes optical and/or radiofrequency (RF) transceivers for transmitting one or more feeder uplink signals 34 to its in-coverage satellite(s) 14, and for receiving one or more downlink signals 36 from such satellite(s) 14. These feeder link signals generally carry traffic for multiple UTs 20 according to a defined multiplexing scheme.

Further example details in FIG. 1 include the illustration of beams 40, with the directional orientation and size of each beam 40 defining the coverage area of the respective satellite 14. The illustrated beams 40 may be associated with coverage of the respective satellites 14 in the forward and/or return directions, with each beam 40 having a beam footprint 42 that follows a ground track on the Earth's surface corresponding to the orbital path of the corresponding satellite 14. As noted, cooperative beamforming may be used for serving a given UT 20 in the diversity service mode, such as where respective beams 40 from two serving satellites 14 are cooperatively controlled in terms of phase, timing, frequency, etc., to produce constructive combination of the beams at the particular location of the given UT 20.

Further, the satellites 14 may support the formation of multiple beams 40 simultaneously, e.g., at different frequencies and/or polarizations. Thus, FIG. 1 merely serves as an illustrative example of satellite coverage areas for transmitting user downlink signals 44 conveying forward user traffic to respective UTs 20 and receiving user uplink signals 46 conveying return user traffic from respective UTs 20. The satellites 14 in one or more embodiments further include inter-satellite links 48, for mesh-based routing of user traffic between serving and non-serving satellites 14 in the constellation 12, for given traffic flows.

In one or more embodiments, the relative beam orientation for each satellite 14 is fixed or is otherwise controlled on an open-loop basis. In one or more other embodiments, the satellites 14 perform closed-loop control of their beamforming. A particular example of closed-loop beamforming is where two or more satellites 14 participate in cooperative beamforming for serving a UT 20 using Multiple-Input-Multiple-Output (MIMO) or Multiple-Input-Single-Output (MISO) diversity. Here, MIMO and MISO are example diversity techniques used by the SCN 10 when serving a UT 20 in the diversity service mode.

In at least one embodiment, the SCN 10 supports two or more diversity techniques, and given UTs 20 being served in the diversity service mode are not necessarily served using the same diversity technique. For example, the particular diversity technique used may be based on known or estimated channel conditions and/or the particular type or priority of communication service involved. Thus, in one or more embodiments, the SCN 10 may use different diversity techniques at different times, such as for different UTs 20 experiencing different conditions or using different communication services.

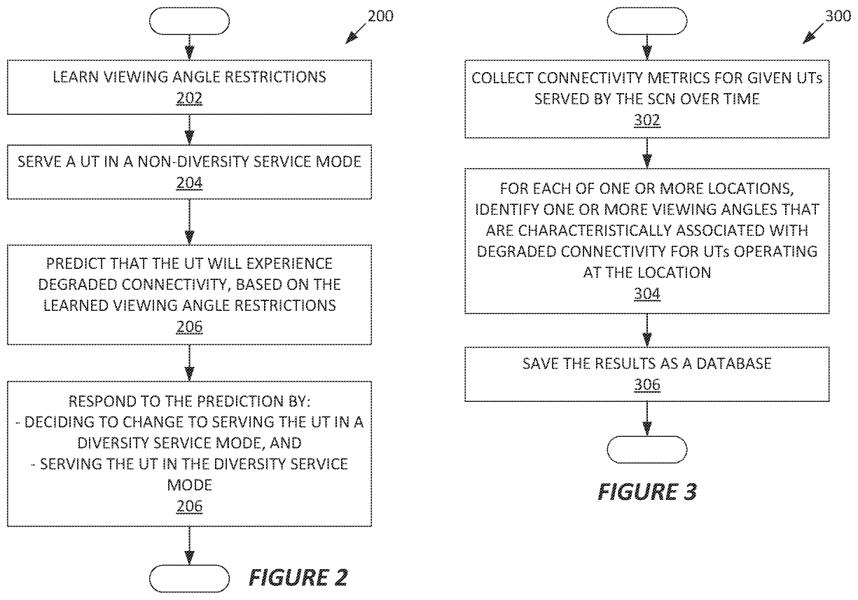

FIG. 2 illustrates an example method 200 of operation by the diversity control apparatus 22. For example, the diversity control apparatus 22 comprises a computer server with memory storing computer program instructions that, when executed by a microprocessor of the computer server, cause the computer server to carry out the method 200.

The method 200 includes learning (Block 202) viewing angle restrictions for corresponding geographic locations, based on collecting connectivity metrics over time for given UTs operating in the corresponding locations, wherein the connectivity metrics collected for each such location indicate viewing angles characteristically associated with degraded connectivity. The learning step 202 may be performed one or more times, and it should be understood that learning may be ongoing or performed on a repeated basis, based on continuing observations of connectivity metrics-such as received signal quality or strength or error rates or dropped connections, or other such metrics indicative of instances of degraded connectivity between given UTs 20 and their serving satellites 14.

The method 200 further comprises serving (Block 204) a UT 20 in a non-diversity service mode, in which there is a single serving satellite 14 at a time in the constellation 12 for the UT 20 and predicting (Block 206) that the UT 20 will experience degraded connectivity, based on the learned viewing angle restrictions. The method 200 further includes responding (Block 208) to the prediction by: deciding to change from serving the UT 20 in the non-diversity service mode to serving the UT 20 in a diversity service mode, in which there are two or more serving satellites at a time in the constellation for the UT 20; and serving the UT 20 in the diversity service mode.

Predicting that the UT 20 will experience degraded connectivity in one or more embodiments is based on the learned viewing angle restrictions, a location of the UE, and serving-satellite ephemeris, and determining from that data that serving the UT in the non-diversity service mode will involve a restricted viewing angle. For example, over one or more observation intervals, the SCN 10 collects connectivity metrics for given UTs 20 operating at many different locations, with the collected metrics used to identify, for each of one or more locations, viewing angles that are characteristically associated with degraded connectivity.

In a particular example, the learned viewing angle restrictions are represented in a database that links each one among a plurality of respective locations with corresponding viewing angle restrictions learned for the respective location. Here, predicting that the UT will experience degraded connectivity comprises indexing into the database as a function of the location of the UT, to determine viewing angle restrictions applicable to the location of the UT, and determining from serving-satellite ephemeris that the UT 20 will experience one or more restricted viewing angles. In other words, as an example of predicting degraded connectivity, the diversity control apparatus 22 determines that a serving satellite 14 of the UT 20 will be in or pass through a position that corresponds with a viewing angle from the location of the UT 20 that is known or expected to have degraded connectivity.

It may be that the location of the UT 20 does not match any of the database locations for which viewing angle restrictions were learned. However, one or more embodiments of the method 200 include determining the viewing angle restrictions applicable to the location of the UT by performing an interpolation or extrapolation of viewing angle restrictions corresponding to one or more locations in the database that are closest to the location of the UT 20. The determination may consider vector relationships—distance and direction—between the nearest database location(s) and the UT location, to determine the restricted viewing angles applicable to the location of the UT. Additionally, or alternatively, the database may include information about the location and orientation of presumed obstructions and use such information to estimate the restricted viewing angles for a location not represented in the database.

As an alternative, in one or more embodiments of the method, the learned viewing angle restrictions are represented in a trained machine learning (ML) model that outputs viewing angle restrictions applicable to an input location. Here, predicting that the UT 20 will experience degraded connectivity comprises inputting the UT location into the trained ML model, and evaluating serving-satellite ephemeris to determine whether the UT 20 will experience a restricted viewing angle, as indicated by the applicable viewing angle restrictions output by the trained ML model.

As noted, any given viewing angle comprises an Azimuth angle (Az) and an Elevational angle (El). As such, viewing angle restrictions may be expressed as individual viewing angles or ranges of viewing angles. Further, restricted viewing angles may be identified implicitly and dynamically, rather than on an explicit or fixed basis. For example, connectivity metrics collected over time with respect to a particular location may reveal characteristic channel qualities for different viewing angles or ranges. With such data captured in a database, the viewing angles that are considered restricted may be defined dynamically, by specifying a minimum characteristic channel quality, and such minimums may be different for different communication services. Similarly, the collected metrics may be used to assign a grade or other rank to given viewing angles or ranges of viewing angles for a particular location, such that whether a viewing angle or range of viewing angle is considered restricted depends upon a minimum acceptable grade. Again, the acceptable grade may be varied, such as a function of SCN loading to bias the diversity decision control towards or away from diversity service and/or as a function of the involved type of communication service.

Further, in the context of the method 200, serving the UT 20 in the diversity service mode comprises serving the UT 20 in one or both of a forward diversity service mode and a return diversity service mode. Serving the UT 20 in the return diversity service mode comprises, for example, attempting to receive an uplink transmission from the UT 20 at each of two or more satellites 14 in the constellation 12, such that the SCN 10 receives corresponding return traffic from the UT 20 upon successful reception of the uplink transmission at one or more of the two or more satellites 14.

Serving the UT 20 in the forward diversity service mode comprises, for example, using MIMO or MISO forward downlink transmissions to serve forward data to the UT 20. The MIMO or MISO forward downlink transmissions comprise, for example, cooperative beamforming transmissions from two or more satellites 14 in the constellation 12. The cooperative beamforming includes cooperatively setting across the two or more satellites 14 of any one or more of transmit carrier frequency, transmit carrier amplitude, transmit carrier phase, or transmit carrier timing offset, to produce constructive combination of the respective downlink transmit signals from the two or more satellites 14 at the UT 20.

In at least one such embodiment of the method 200, the method further comprises performing beamforming updates for the cooperative beamforming according to a beam update rate that is faster than a channel sounding rate. Here, the channel sounding rate determines a rate at which the SCN 10 obtains updated Channel State Information (CSI) based on the transmission of reference signals over the physical propagation channels linking respective UTs 20 to the SCN 10, and wherein the SCN 10 supports the faster beam update rate by predicting changes in the CSI between CSI updates. More generally, in one or more embodiments that use cooperative beamforming, the method includes updating channel estimates used for the cooperative beamforming to account for relative changes in position among the two or more satellites 14 participating in the cooperative beamforming.

In one or more embodiments, deciding to change from serving the UT 20 in the non-diversity service mode to serving the UT 20 in the diversity service mode comprises making the decision in further dependence on a latency tolerance associated with a communication service being provided to the UT 20 via the SCN 10. Making the decision in dependence on the latency tolerance associated with the communication service being provided to the UT 20 via the SCN 10 comprises, for example, deciding to change to the diversity service mode responsive to stored configuration information identifying the communication service as being latency sensitive. In the converse case, i.e., where the stored information indicated that the involved communication service was not latency sensitive, the diversity control apparatus 22 would decide not to switch from the non-diversity service mode to the diversity service mode, despite predicting that the UT 20 will experience degraded connectivity.

FIG. 3 illustrates a method 300 carried out by the diversity control apparatus 22, e.g., as part of or in support of performing the method 200. The method 300 includes the diversity control apparatus 22 collecting connectivity metrics for given UTs serviced by the SCN over time (Block 302). Example metrics are QoS values, SINR, received signal strength, etc.

The method 300 continues with the diversity control apparatus 22 identifying, for each of one or more locations, viewing angles that are characteristically associated with degraded connectivity for UTs 20 operating at the location (Block 304). The results of the identification are saved as a database (Block 306), for use by the diversity control apparatus 22 in making live diversity control decisions with respect to given UTs 20.

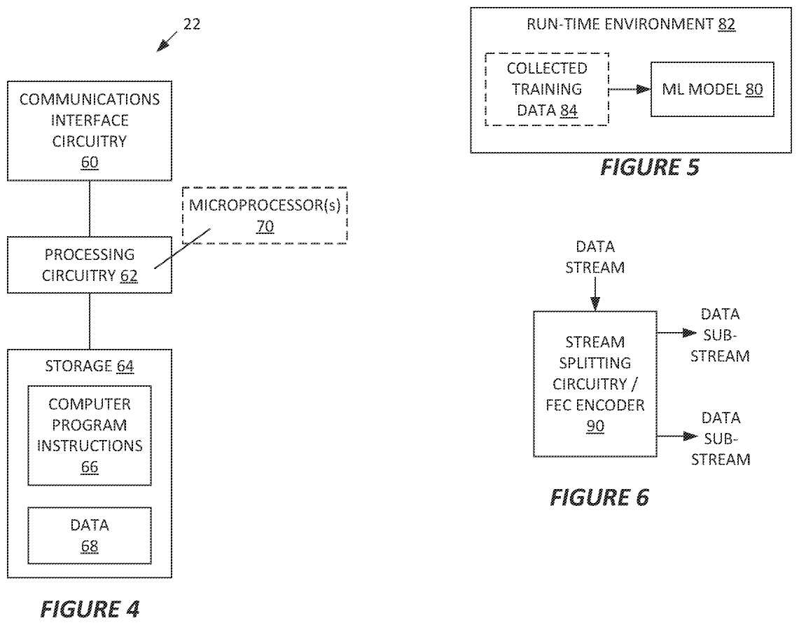

FIG. 4 depicts an example implementation of the diversity control apparatus 22, which may be configured to perform the operations comprised in the methods 200 and 300, along with any one or more of the extensions and variations described herein. The example diversity control apparatus 22 is configured to operate in the SCN 10 and comprises communication interface circuitry 60 and processing circuitry 62 that is operatively associated with the communication interface circuitry 60.

In an example implementation where the diversity control apparatus 22 is implemented separately from the CPS 24, the communication interface circuitry 60 comprises, for example, an Ethernet interface or other data network interface, which is used by the processing circuitry 62 to exchange control signaling with the CPS 24. Such signaling indicates diversity/non-diversity decisions made by the processing circuitry 62, to initiate or otherwise control configuration of the SCN 10 selectively serving given UTs 20 using a diversity service mode or a non-diversity service mode. For example, saying that the diversity control apparatus 22 “serves” a UT 20 in the non-diversity service mode or in the diversity service mode can be understood as saying that the diversity control apparatus 22 outputs control signaling to cause the SCN 10 to perform such operations.

In another example implementation, the diversity control apparatus 22 is integrated with the CPS 24. In such cases, the communication interface circuitry 60 may comprise a data bus interface or other inter-processor interface internal within a computer server or other node comprising the CPS 24.

The processing circuitry 62 comprises, for example, one or more microprocessors 70 that are specially adapted to carry out the method 200 and/or 300 based on the execution of computer program instructions held in a computer readable medium. As such, FIG. 4 illustrates memory or other storage 64, storing computer program instructions 66 for execution by the one or more microprocessors 70. The same storage 64 may further store data 68, such as configuration data that governs diversity/non-diversity decision making by the diversity control apparatus 22. In at least one embodiment, the data 68 includes a database, such as the database 50 shown in FIG. 1. The database 50 contains information indicating learned viewing angle restrictions for one or more locations. In at least one embodiment, the data 68 comprises training and parameter data for a machine learning (ML) model 80, such as shown in FIG. 5.

In the context of FIG. 5, the processing circuitry 62 provides a run-time environment 82 in which the ML model 80 is instantiated for training and subsequent use as a trained ML model. In at least one embodiment, the diversity control apparatus 22 uses collected training data 84—e.g., raw or filtered connectivity metrics collected over one or more collection intervals—to train the ML model 80. Once trained, the ML model 80 takes an input location and outputs viewing angle restrictions associated with the input location. The input location need not match any particular one of the locations represented in the collected training data 84.

Broadly, whether implemented as shown in FIG. 4 or 5, an example SCN 10 includes control circuitry that is configured to decide whether or when to serve individual UTs 20 or groups of UTs 20 supported by the SCN 10 using a diversity service mode or a non-diversity service mode. In at least one embodiment, the CPS 24 includes stream splitting/encoding circuitry 90, such as shown in FIG. 6. In an example scenario, the control circuitry decides to change from serving a UT 20 in the non-diversity service mode to serving the UT 20 in the diversity service mode, and it sends corresponding control signaling to the CPS 24 and/or elsewhere in the SCN 10 to initiate or otherwise time the changeover.

In an example forward diversity technique used for serving the UT 20 in the diversity service mode, a forward data stream, such as an IP packet flow, is targeted for delivery to the UT 20 via the SCN 10. For diversity transmission of the forward data stream, the circuitry 90 splits the forward data stream into as many data sub-streams as there are satellites 14 being used for serving the UT 20 in the diversity service mode. Each satellite 14 transmits a respective one of the data sub-streams, and the circuitry 90 in one or more embodiments is configured to apply Forward Error Correction (FEC) coding to the data sub-streams, such that the UT 20 may recover the full data stream even in the presence of impairments affecting any given one or more of the data sub-streams.

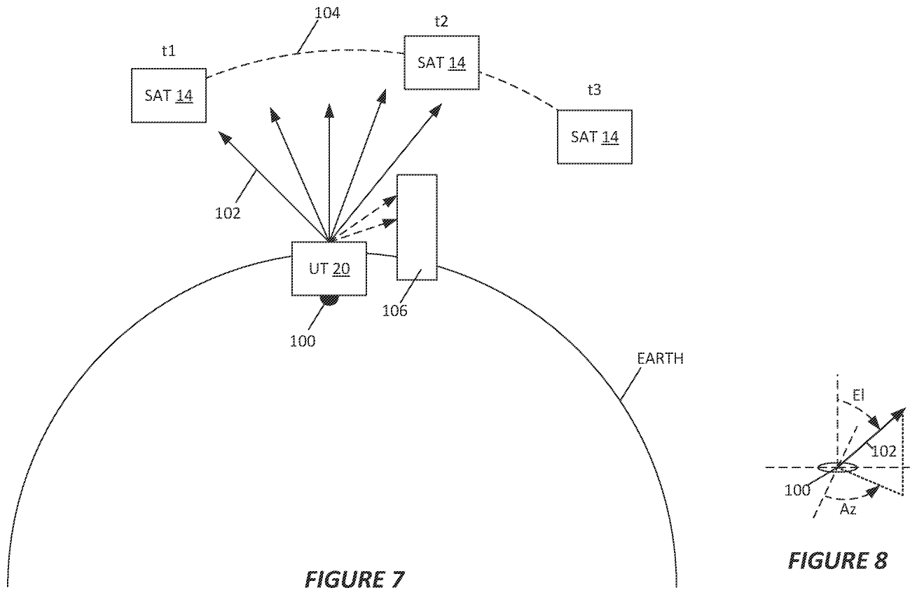

FIGS. 7 and 8 are diagrams depicting example details aiding in the understanding of viewing angle restrictions. In FIG. 7, a UT 20 is at a given location 100 on the surface of the Earth and is served by a single serving satellite 14. The UT 20 experiences different viewing angles 102 as the serving satellite 14 moves along its orbital path 104. The diagram suggests such movement by showing the serving satellite in three different positions relative to the UT 20, a first position at time t1, a second position at time t2, and a third position at time t3. One sees that the UT 20 enjoys a clear LoS to the satellite 14 over a range of viewing angles, but a proximate obstruction 106 interferes with viewing angles 102 in a corresponding range. The diagram uses solid lines to depict viewing angles 102 that are not impaired and uses dashed lines to depict viewing angles 102 that are impaired by the obstruction 106. As FIG. 8 reiterates, any given viewing angle may be understood as corresponding to a directional line going from the UT 20 to the satellite 14 and may be expressed as a pair of Az and El values.

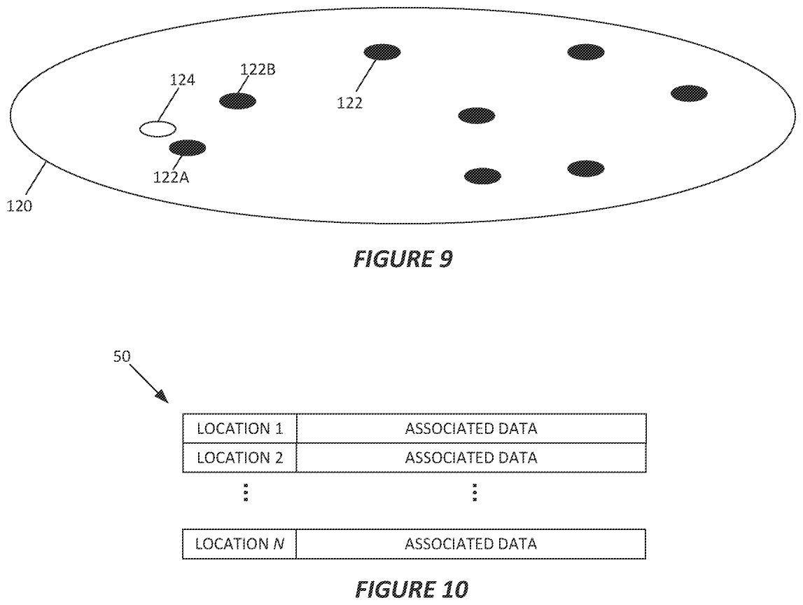

FIG. 9 illustrates a satellite service area 120, which is a potentially large geographic region. Certain locations 122 within the satellite service area 120 are characterized in terms of restricted viewing angles. These characterized locations 122 are shown as filled ellipses within the satellite service area 120. To determine the viewing angle restrictions applicable to a location 124 that has not been characterized, the diversity control apparatus 22 may extrapolate or otherwise infer restrictions from a nearest characterized location, shown as location 122A in the diagram, or it may interpolate or otherwise infer restrictions using two (or more nearest neighbors), e.g., the characterized locations 122A and 122B shown in FIG. 9.

FIG. 10 illustrates example contents for a database 50 that contains information indicating or otherwise representing viewing angle restrictions learned for multiple locations. Each database entry represents a location, which may be a “spot” or “zone” rather than merely a pinpoint location. The associated data stored for each location may comprise vector data representing restricted or unrestricted viewing angles, channel quality data organized by viewing angle, etc. Such data may be expressed for different quantized ranges of viewing angles within the overall nominal range of viewing angles, rather than expressed for discrete, individual viewing angles.

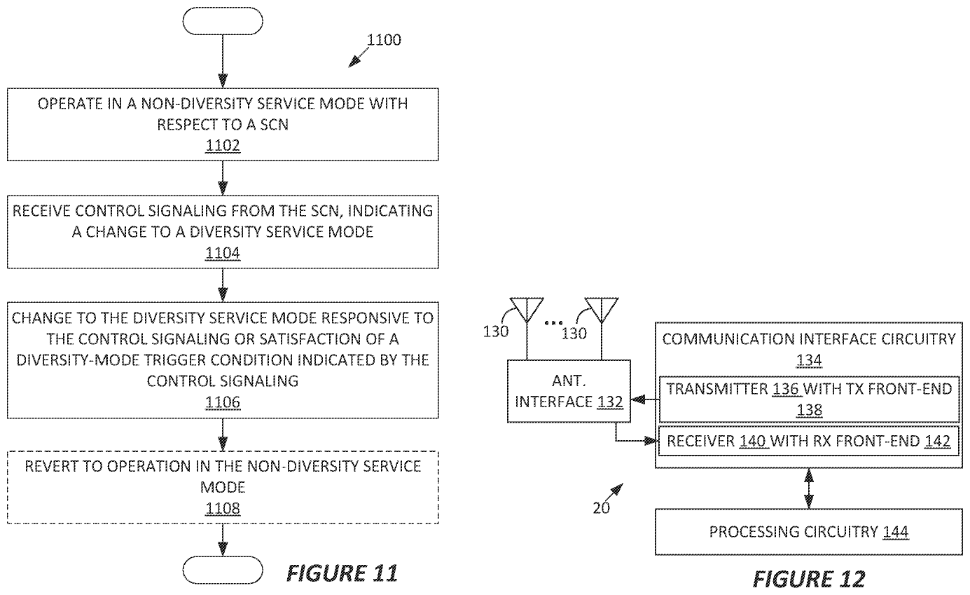

FIG. 11 illustrates a method 1100 of operation by a UT 20. The method 1100 includes the UT 20 operating (Block 1102) in a non-diversity service mode, wherein the SCN 10 serves the UT 20 via a single serving satellite 14 at a time in the constellation 12 of satellites 14. The method 1100 further includes the UT 20 receiving (Block 1104) control signaling from the SCN 10, indicating a change from the non-diversity service mode to a diversity service mode, wherein the SCN serves the UT via two or more serving satellites 14 at a time in the constellation 12. Still further, the method 1100 includes the UT 20 changing (Block 1106) from operating in the non-diversity service mode to operating in the diversity service mode, in response to one of: reception of the control signaling, or satisfaction of a diversity-mode trigger condition indicated by the control signaling. The method 1100 may further include a later reversion (Block 1108) of the UT 20 back into operation in the non-diversity service mode.

In one example, the change to diversity operation is in response to the diversity-mode trigger condition. As a particular example, the diversity-mode trigger condition is a time indicated in the control signaling, wherein the time is associated with the UT experiencing a viewing angle determined by the SCN 10 as restricted. In another example, the diversity-mode trigger condition is handover of the UT to a particular satellite 14 in the constellation 12 as a new serving satellite 14.

Operating in the diversity service mode comprises, for example, the UT 20 receiving a forward data stream as two or more forward data sub-streams transmitted from respective ones of the two or more serving satellites 14. Receiving the forward data stream transmitted as the two or more forward data sub-streams comprises, for example, the UT 20 receiving a MIMO or MISO transmission from the two or more serving satellites 14. Receiving the MIMO or MISO transmission comprises, for example, the UT 20 using a single radio front end to receive the MIMO or MISO transmission.

In at least one embodiment, the UT 20 receiving a forward data stream as two or more forward data sub-streams comprises the UT 20 receiving each forward data sub-stream on a respective frequency or polarization or at a respective transmission time.

In at least one embodiment, for serving the UT 20 in the diversity service mode, the SCN 10 transmits a same forward data stream from each of two or more serving satellites 14, such that transmission is successful based on successful reception at the UT 20 from any one or more of the two or more serving satellites 14.

In at least one embodiment, with respect to operation of the UT 20 in the diversity service mode, the method 1100 includes the UT 20 dividing a return data stream into two or more return data sub-streams, with each return data sub-stream for reception by a respective one among the two or more serving satellites 14.

In at least one embodiment, reversion by the UT 20 back to the non-diversity service mode is done responsive to a reversion trigger condition, such as a next serving-satellite handover, or after expiration of a timer. As another example, reversion is based on receiving further control signaling at the UT 20 from the SCN 10.

FIG. 12 illustrates an example UT 20 comprising one or more antennas 130 and an associated antenna interface 132 that couples the antenna(s) 130 with communication interface circuitry 134. The communication interface circuitry 134 is configured to communicate with the SCN 10, via exchanging wireless signaling with one or more satellites 14 in the constellation 12.

In the example depiction, the communication interface circuitry includes a transmitter 136 having a transmitter (TX) front-end 138. The TX front-end 138 includes analog circuitry for upconversion and amplification of a signal for transmission from the antenna(s) 130 as an uplink signal for reception at one or more satellites 14 in the constellation 12. The communication interface circuitry 134 further includes a receiver 140 having a receiver (RX) front-end 142. The RX front-end 142 comprises analog circuitry configured for filtering, amplification, and downconversion of downlink signals received on the antenna(s) 130 from one or more satellites 14 in the constellation 12.

In one or more embodiments, the RX front-end 142 has a wide bandwidth and supports simultaneous reception of two or more downlink signals at different downlink carrier frequencies, provided that each of the downlink carrier frequencies is within the radiofrequency spectrum spanned by the reception bandwidth of the RX front-end 142. Such simultaneous reception is used, for example, to support simultaneous reception of MIMO or MISO transmissions for forward diversity service, and, more generally, may be used to support simultaneous reception of different data sub-streams or duplicate streams transmitted simultaneously from different satellites 14 at different downlink carrier frequencies.

Baseband processing of transmit and receive signals may be performed by a baseband processor included in the communication interface circuitry 134 or included in the processing circuitry 144, which is operatively associated with the communication interface circuitry 134.

In one or more embodiments, the processing circuitry 144 is configured to: operate the UT 20 in a non-diversity service mode, wherein the SCN 10 serves the UT 20 via a single serving satellite 14 at a time in the constellation 12. Further, the processing circuitry 144 is configured to receive control signaling from the SCN (via the communication interface circuitry 134), where the control signaling indicates a change from the non-diversity service mode to a diversity service mode, wherein the SCN 10 serves the UT 20 via two or more serving satellites 14 at a time in the constellation 12. Still further, the processing circuitry 144 is configured to change the UT 20 from operating in the non-diversity service mode to operating in the diversity service mode, in response to one of: reception of the control signaling, or satisfaction of a diversity-mode trigger condition indicated by the control signaling.

More broadly, the processing circuitry 144 in one or more embodiments is configured to perform any one or more of the operations belonging to the method 1100, or extensions and variations thereof. In at least one embodiment of operating in the diversity service mode, the processing circuitry 144 is configured to perform return diversity transmissions, in which it divides a return data stream into two or more return data sub-streams that are transmitted for respective ones among two or more serving satellites 14 in the constellation 12. Correspondingly, the processing circuitry 144 in such embodiments includes stream splitting and encoding circuitry like that depicted in FIG. 6, for splitting the return data stream into sub-streams and for applying FEC encoding to the sub-streams.

The processing circuitry 144 comprises fixed circuitry or programmatically configured circuitry or a mix of both. In at least one embodiment, the processing circuitry comprises one or more microprocessors, digital signal processors, or other digital processors that are specially adapted to carry out the operations described herein for the UT 20, based on the execution of computer program instructions stored in a memory of the UT 20.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-46. (canceled)

47. A method performed by a control apparatus operating in a satellite communications network (SCN) comprising a constellation of non-geosynchronous satellites following respective orbital paths, the method comprising:
learning viewing angle restrictions for corresponding geographic locations, based on collecting connectivity metrics over time for given user terminals (UTs) operating in the corresponding locations, wherein the connectivity metrics collected for each such location indicate viewing angles characteristically associated with degraded connectivity;
serving a user terminal (UT) in a non-diversity service mode, in which there is a single serving satellite at a time in the constellation for the UT;
predicting that the UT will experience degraded connectivity, based on the learned viewing angle restrictions; and
responsive to the prediction:
deciding to change from serving the UT in the non-diversity service mode to serving the UT in a diversity service mode, in which there are two or more serving satellites at a time in the constellation for the UT; and
serving the UT in the diversity service mode.

48. The method according to claim 47, wherein predicting that the UT will experience degraded connectivity comprises determining, based on the learned viewing angle restrictions, a location of the UE and serving-satellite ephemeris, that serving the UT in the non-diversity service mode will involve a restricted viewing angle.

49. The method according to claim 47, wherein the learned viewing angle restrictions are represented in a database that links each one among a plurality of respective locations with corresponding viewing angle restrictions learned for the respective location, and wherein predicting that the UT will experience degraded connectivity comprises indexing into the database as a function of the location of the UT, to determine viewing angle restrictions applicable to the location of the UT, and determining from serving-satellite ephemeris that the UT will experience one or more restricted viewing angles.

50. The method according to claim 49, wherein determining the viewing angle restrictions applicable to the location of the UT comprises performing an interpolation or extrapolation of viewing angle restrictions corresponding to one or more locations in the database that are closest to the location of the UT.

51. The method according to claim 47, wherein the learned viewing angle restrictions are represented in a trained machine learning (ML) model that outputs viewing angle restrictions applicable to an input location, and wherein predicting that the UT will experience degraded connectivity comprises inputting the UT location into the trained ML model, and evaluating serving-satellite ephemeris to determine whether the UT will experience a restricted viewing angle, as indicated by the applicable viewing angle restrictions output by the trained ML model.

52. The method according to claim 47, wherein any given viewing angle comprises an Azimuth angle (Az) and an Elevational angle (El), and wherein viewing angle restrictions comprises individual viewing angles or ranges of viewing angles.

53. The method according to claim 47, wherein serving the UT in the diversity service mode comprises serving the UT in one or both of a forward diversity service mode and a return diversity service mode.

54. The method according to claim 53, wherein serving the UT in the return diversity service mode comprises attempting to receive an uplink transmission from the UT at each of two or more satellites in the constellation, such that the SCN receives corresponding return traffic from the UT upon successful reception of the uplink transmission at one or more of the two or more satellites.

55. The method according to claim 53, wherein serving the UT in the forward diversity service mode comprises using Multiple-Input-Multiple-Output (MIMO) or Multiple-Input-Single-Output (MISO) forward downlink transmissions to serve forward data to the UT.

56. The method according to claim 55, wherein the MIMO or MISO forward downlink transmissions comprise cooperative beamforming transmissions from two or more satellites in the constellation, wherein the cooperative beamforming includes cooperatively setting across the two or more satellites of any one or more of transmit carrier frequency, transmit carrier amplitude, transmit carrier phase, or transmit carrier timing offset, to produce constructive combination of the respective downlink transmit signals from the two or more satellites at the UT.

57. The method according to claim 56, wherein the method further comprises performing beamforming updates for the cooperative beamforming according to a beam update rate that is faster than a channel sounding rate, wherein the channel sounding rate determines a rate at which the SCN obtains updated Channel State Information (CSI) based on the transmission of reference signals over the physical propagation channels linking respective UTs to the SCN, and wherein the SCN supports the faster beam update rate by predicting changes in the CSI between CSI updates.

58. The method according to claim 56, wherein the method further comprises updating channel estimates used for the cooperative beamforming to account for relative changes in position among the two or more satellites participating in the cooperative beamforming.

59. The method according to claim 47, wherein deciding to change from serving the UT in the non-diversity service mode to serving the UT in the diversity service mode comprises making the decision in further dependence on a latency tolerance associated with a communication service being provided to the UT via the SCN.

60. The method according to claim 59, wherein making the decision in dependence on the latency tolerance associated with the communication service being provided to the UT via the SCN comprises deciding to change to the diversity service mode responsive to stored configuration information identifying the communication service as being latency sensitive.

61. A control apparatus configured for operation in a satellite communications network (SCN) comprising a constellation of non-geosynchronous satellites following respective orbital paths, the control apparatus comprising:
communication interface circuitry; and
processing circuitry configured to:
learn viewing angle restrictions for corresponding geographic locations, based on collecting connectivity metrics over time for given user terminals (UTs) operating in the corresponding locations, wherein the connectivity metrics collected for each such location indicate viewing angles characteristically associated with degraded connectivity;
serve a user terminal (UT) in a non-diversity service mode, in which there is a single serving satellite at a time in the constellation for the UT;
predict that the UT will experience degraded connectivity, based on the learned viewing angle restrictions; and
responsive to the prediction:
decide to change from serving the UT in the non-diversity service mode to serving the UT in a diversity service mode, in which there are two or more serving satellites at a time in the constellation for the UT; and
serve the UT in the diversity service mode.

62. The control apparatus according to claim 61, wherein, with respect to predicting that the UT will experience degraded connectivity, the processing circuitry is configured to determine, based on the learned viewing angle restrictions, a location of the UE, and serving-satellite ephemeris, that serving the UT in the non-diversity service mode will involve a restricted viewing angle.

63. The control apparatus according to claim 61, wherein the learned viewing angle restrictions are represented in a database that links each one among a plurality of respective locations with corresponding viewing angle restrictions learned for the respective location, and wherein, with respect to predicting that the UT will experience degraded connectivity, the processing circuitry is configured to index into the database as a function of the location of the UT, to determine viewing angle restrictions applicable to the location of the UT, and determine from serving-satellite ephemeris that the UT will experience one or more restricted viewing angles.

64. The control apparatus according to claim 63, wherein the processing circuitry is configured to determine the viewing angle restrictions applicable to the location of the UT by performing an interpolation or extrapolation of viewing angle restrictions corresponding to one or more locations in the database that are closest to the location of the UT.

65. The control apparatus according to claim 61, wherein the learned viewing angle restrictions are represented in a trained machine learning (ML) model that outputs viewing angle restrictions applicable to an input location, and wherein, with respect to predicting that the UT will experience degraded connectivity, the processing circuitry is configured to input the UT location into the trained ML model, and evaluate serving-satellite ephemeris to determine whether the UT will experience a restricted viewing angle, as indicated by the applicable viewing angle restrictions output by the trained ML model.

66. The control apparatus according to claim 61, wherein any given viewing angle comprises an Azimuth angle (Az) and an Elevational angle (El), and wherein viewing angle restrictions comprise individual viewing angles or ranges of viewing angles.

67. The control apparatus according to claim 61, wherein the diversity service mode comprises serving the UT in one or both of a forward diversity service mode and a return diversity service mode.

68. The control apparatus according to claim 67, wherein, with respect to serving the UT in the return diversity service mode, the processing circuitry is configured to control the SCN to attempt to receive an uplink transmission from the UT at each of two or more satellites in the constellation, such that the SCN receives corresponding return traffic from the UT upon successful reception of the uplink transmission at one or more of the two or more satellites.

69. The control apparatus according to claim 67, wherein, with respect to serving the UT in the forward diversity service mode, the control apparatus is configured to activate Multiple-Input-Multiple-Output (MIMO) or Multiple-Input-Single-Output (MISO) forward downlink transmissions to serve forward data to the UT.

70. The control apparatus according to claim 69, wherein the MIMO or MISO forward downlink transmissions comprise cooperative beamforming transmissions from two or more satellites in the constellation, wherein the cooperative beamforming includes cooperatively setting across the two or more satellites of any one or more of transmit carrier frequency, transmit carrier amplitude, transmit carrier phase, or transmit carrier timing offset, to produce constructive combination of the respective downing transmit signals from the two or more satellites at the UT.

71. The control apparatus according to claim 70, wherein the processing circuitry is configured to perform beamforming updates for the cooperative beamforming according to a beam update rate that is faster than a channel sounding rate, wherein the channel sounding rate determines a rate at which the processing circuitry obtains updated Channel State Information (CSI) based on the transmission of reference signals over the physical propagation channels linking respective UTs to the SCN, and wherein the control apparatus supports the faster beam update rate by predicting changes in the CSI between CSI updates.

72. The control apparatus according to claim 70, wherein the control apparatus is configured to update channel estimates used for the cooperative beamforming to account for relative changes in position among the two or more satellites participating in the cooperative beamforming.

73. The control apparatus according to claim 61, wherein, with respect to deciding to change from serving the UT in the non-diversity service mode to serving the UT in the diversity service mode, the processing circuitry is configured to make the decision in further dependence on a latency tolerance associated with a communication service being provided to the UT via the SCN.

74. The control apparatus according to claim 73, wherein, with respect to making the decision in further dependence on the latency tolerance, the processing circuitry is configured to decide to change to the diversity service mode responsive to stored configuration information identifying the communication service as being latency sensitive.
